(19) United States
(12) Patent Application Publication
(10) Pub. No.: US 2023/0187702 A1
(43) Pub. Date: Jun. 15, 2023

(54) WIDE TEMPERATURE ELECTROLYTE

(71) Applicant: FastCAP Systems Corporation, Wakefield, MA (US)

(72) Inventor: John Hyde, Ashland, MA (US)

(21) Appl. No.: 17/923,680

(22) PCT Filed: May 7, 2021
(86) PCT No.: PCT/US2021/031331

§ 371 Date: Nov. 7, 2022

Related U.S. Application Data
(60) Provisional application No. 63/021,492, filed on May 7, 2020.

(51) Int. Cl. H01M 10/0569; H01G 11/60; H01G 11/62; H01M 10/0568; H01M 10/0525

(52) U.S. Cl. CPC H01M 10/0569; H01G 11/60; H01G 11/62; H01M 10/0568; H01M 10/0525; H01G 11/64

(57) ABSTRACT

An electrolyte includes a lithium salt dissolved in a solvent mixture. The solvent mixture may include a first solvent component including an organic solvent having no carbonate groups; a second solvent component configured to improve the electrochemical properties of the first solvent at low temperatures; a third solvent compound configured to promote formation of a passivating SEI layer between the electrolyte and an electrode layer; and a fourth solvent compound configured to stabilize a lithium salt at high temperatures.

### CROSS REFERENCE TO RELATED APPLICATIONS

The present application claims priority under 35 U.S.C. § 119(e) to U.S. provisional application U.S. Ser. No. 63/021,492 filed May 7, 2020, which is incorporated herein by reference.

### BACKGROUND

A stable supply of energy is one of the most important factors in the operation of various electronic products such as electrical components in automotive, networked devices used in the so-called Internet of Things and the like. In some cases, this energy supply function is performed by a capacitor. That is, the capacitor serves to charge and discharge electricity in and from circuits of electronic devices, thereby making it possible to stabilize the electricity flow in the circuits. The general capacitor has a very short charging and discharging time and a long lifespan but has a limitation when being used as a storage device due to a high output density and a small energy density.

In order to overcome this limitation, a new capacitor such as an electric double layer (“EDLC”) capacitor having a very short charging and discharging time combined with high energy power density has recently been developed, which has drawn much attention as a next-generation energy device. While such devices exhibit higher energy density than conventional capacitors, it may not be so high as that exhibited by some batteries, such as a rechargeable lithium ion battery (“LiB”).

Recently, various electrochemical capacitors operated on a principle similar to the electric double layer capacitor have been developed. An energy storage device called a hybrid capacitor operating on a combination of charging principles of the lithium ion rechargeable battery and the electric double layer capacitor, has come into prominence. Consequently, the hybrid capacitor, a lithium ion capacitor having the high energy density of a rechargeable battery and the high output characteristics of an electric double layer capacitor has been of interest.

The lithium ion capacitor contacts an anode capable of absorbing and separating lithium ions to a lithium metal to previously absorb (or dope) the lithium ions in the anode by using a chemical method or an electrochemical method, and lowers a cathode potential to increase the withstand voltage and remarkably increase the energy density.

However, when the electrolyte used in the rechargeable battery of the related art is used in the lithium ion capacitor (“LiC”), there are problems in that the capacity thereof is degraded, the resistance is increased, and the output characteristics are degraded, especially under low temperature conditions. Similarly, such electrolytes may exhibit a high degree of performance degradation at high temperatures.

### SUMMARY

The present invention comprises an electrolyte formulation that advantageously provides high performance across a wide temperature range when used in energy storage devices including EDLCs, LiCs, and LiBs.

In one embodiment, the electrolyte comprises a solvent mixture that is selected, e.g., to promote the stability and uniformity of the solid electrolyte interphase (SEI). Solvents useful for this purpose include non-aqueous aprotic solvents. For example, the solvent mixture may comprise one or more of the following: a first solvent component including an organic solvent having no carbonate groups; a second solvent component including a compound configured to improve the electrochemical properties of the first solvent at low temperatures; a third solvent compound configured to promote formation of a passivating SEI between the electrolyte and an electrode layer; and a fourth solvent compound configured to stabilize a lithium salt at high temperatures. In an embodiment, the electrolyte comprises a lithium salt dissolved in the solvent mixture.

In some embodiments, the lithium salt comprises a lithium cation and an organic anion. In some embodiments, the organic anion may include one or more sulfur−containing functional groups (e.g., sulfonyl groups). In some embodiments, the organic anion may include at least two halogen groups; at least three halogen groups; at least four halogen groups; at least five halogen groups; or at least six halogen groups. The halogen groups may be fluorine groups. In some embodiments, the organic anion may be a symmetric molecule centered about a nitrogen atom; the organic anion may include two chains extending from this central nitrogen atom, each including a sulfur containing group (e.g., a sulfonyl group). In some embodiments, the sulfonyl group may be a sulfonyl halide. In some embodiments, the lithium salt comprises a lithium bis(fluorosulfonyl)imide, such as lithium bis(fluorosulfonyl)imide (LiFSI) or lithium bis(trifluoromethanesulfonyl)imide (LiTFSI). In some embodiments, the lithium salt may consist essentially of lithium bis(trifluoromethanesulfonyl)imide. In some embodiments, the lithium salt consists of lithium bis(trifluoromethanesulfonyl)imide.

In some embodiments, the first solvent compound comprises an alkyl butyrate compound, wherein the alkyl moiety comprises one to four carbon atoms. In some embodiments, the first solvent comprises methyl butyrate (MB), ethyl butyrate (EB) or butyl butyrate BB). In some embodiments, the first solvent may comprise butyronitrile (BCN).

In some embodiments, the second solvent compound is an organic compound that inhibits lithium dendrite formation at very low temperatures, e.g., at temperatures below about −40° C. to below about −60 C. In some embodiments, second solvent compound comprises a cyclic carboxylic ester, e.g., a lactone compound containing a 1-oxacycloalkan-2-one structure (—C(═O)—O—), or an analog having unsaturation or heteroatoms replacing one or more carbon atoms of the ring. In some embodiments, the second solvent comprises gamma-butyrolactone (GBL). In some embodiments, the second solvent comprises an alkyl carbonate compound, wherein the alkyl moiety comprises one to five carbon atoms. In some embodiments, the second solvent compound composes ethylene carbonate (EC), diethyl carbonate (DEC), propylene carbonate (PC), ethylmethyl carbonate (EMC) or dimethyl carbonate (DMC).

In some embodiments, the third solvent compound is selected such that a substantial fraction of the compound is expended during formation of the SEI. In some embodiments, the third solvent compound comprises an unsaturated cyclic carbonic acid ester. In some embodiments, the third solvent comprises vinylene carbonate (VC) or fluoroethylene carbonate (FEC).

In some embodiments, the fourth solvent compound comprises a high-temperature resistant solvent capable of stabilizing a lithium salt at high temperatures e.g., at temperatures above 90° C. In some embodiments, the fourth solvent comprises an organosilicon (OS) compound, e.g., a haloalkylsilyl derivative, such as 4-[fluoro(dimethyl)silyl]butanenitrile.

In some embodiments, the electrolyte may contain one or more additives, for example, lithium bis(oxalate)borate (LiBOB); lithium hexafluorophosphate (F₆LiP); or lithium difluoro(oxalate)borate (LiFDOB) compounds. These additives may be used to increase high temperature stability.

In some embodiments, the electrolyte is included within an energy storage device, e.g., a lithium ion capacitor or a lithium ion battery or an electric double later capacitor.

In another embodiment, a method of making an electrolyte is provided. The method includes: providing a solvent mixture including a first solvent component including an organic solvent having no carbonate groups; a second solvent component including a compound configured to improve the electrochemical properties of the first solvent at low temperatures; a third solvent compound configured to promote formation of a passivating SEI between the electrolyte and an electrode layer; and a fourth solvent compound configured to stabilize a lithium salt at high temperatures; and providing a lithium salt with the lithium salt dissolved in the solvent mixture.

In another embodiment, a method of making an energy storage device is provided. The method includes providing an energy storage cell including a pair of electrodes separated by a separator, and wetting the electrodes with electrolyte as disclosed herein.

The method may include applying a voltage to the energy storage cell at a first temperature to partially form a passivating SEI layer between the electrolyte and at least one of the electrodes.

Applying a voltage to the energy storage cell may be at a first temperature to partially form a passivating SEI layer between the electrolyte and at least one of the electrodes, and includes expending a portion of the third solvent compound.

Applying a voltage to the energy storage cell may be at a second temperature higher than the first temperature to complete formation of the passivating SEI layer between the electrolyte and at least one of the electrodes, and includes expending a portion of the third solvent compound.

### BRIEF DESCRIPTION OF THE DRAWINGS

FIG. 1 is a schematic of a lithium ion capacitor.

FIGS. 2A-B show exemplary recipes for an electrolyte according to the invention.

FIG. 3 is table of exemplary performance characteristics for a lithium ion capacitor including an electrolyte according to the invention.

FIG. 4 is a flow chart illustrating a method of making an electrolyte according to the invention.

FIG. 5 is an illustration of a temperature ramp for a capacitor formation process utilizing an electrolyte according to the invention.

FIG. 6 is a graph depicting cell voltage versus discharge capacity.

FIG. 7(A) is a graph of discharge capacity versus cycle number.

FIG. 7(B) is a graph of ESR versus cycle number.

FIG. 8A is a graph of percent discharge capacity versus cycle number for the Example cell #1 of Table 2.

FIG. 8B is a graph that depicts ESR versus cycle number for the Example cell #1 of Table 2.

### DETAILED DESCRIPTION

Hereinafter, exemplary embodiments of the present invention will be described in detail. However, the exemplary embodiments of the present invention may be modified in many different forms and the scope of the invention should not be limited to the embodiments set forth herein. Rather, these embodiments are provided so that this disclosure will introduce the technology, and will convey the concept of the invention to those skilled in the art. In the drawings, the shapes and dimensions may be exaggerated for clarity, and the same reference numerals will be used throughout to designate the same or like components.

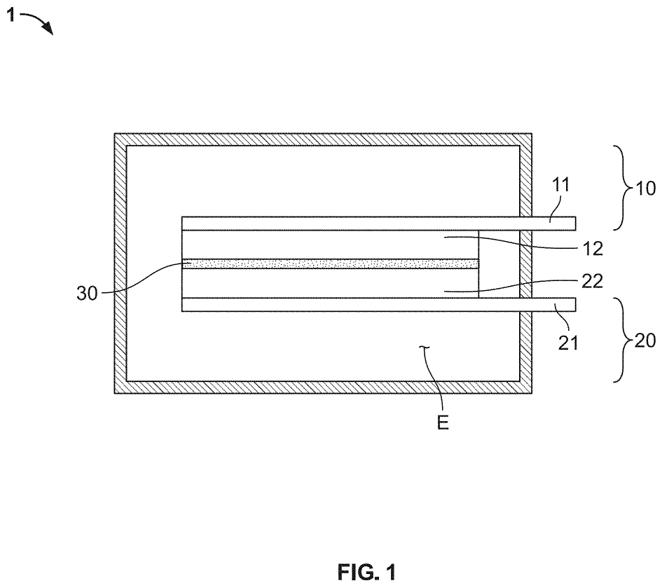

FIG. 1 is a schematic cross-sectional view showing aspects of a lithium ion capacitor according to an exemplary embodiment. In this example, a lithium ion capacitor 1 includes a first electrode 10 and a second electrode 20 that are disposed to be opposite to each other, a separating membrane 30 that is disposed between the first and second electrode, and an electrolyte E impregnating the first electrode, the second electrode, and the separating membrane.

Electricity having different polarities is applied to the first and second electrodes 10 and 20. A plurality of first and second electrodes may be stacked in order to obtain the desired electricity capacity.

In the exemplary embodiment, the first electrode 10 may be set to be a “cathode” and the second electrode 20 may be set to be an “anode”.

The first electrode 10 may be made by forming a first electrode material 12 on a first conductive sheet 11.

The first electrode material 12 can reversibly carry lithium ions but is not limited thereto. For example, the first electrode material 12 may use carbon materials, such as graphite, hard carbon, cokes, or the like, and polyacene-based materials. In some embodiments the electrode may be a composite electrode of the type described in, for example, U.S. Pat. No. 10,600,582, entitled “Composite Electrode,” issued on Mar. 24, 2020; U.S. Pat. No. 9,001,495, entitled “High power and high energy electrodes using carbon nanotubes,” issued on Apr. 7, 2015 and also U.S. Pat. No. 9,218,917, entitled “Energy storage media for ultracapacitors,” issued on Dec. 22, 2015, the entire disclosures of which are incorporated by reference herein

In addition, the first electrode 10 may be formed by mixing the first electrode material 12 with the conductive materials but the conductive material is not limited thereto. For example, the conductive materials may include acetylene black, graphite, metal powder, or the like.

The thickness of the first electrode material 12 is not specifically limited but may be formed to be, for example, 15 to 100 μm.

The first conductive sheet 11 serves as a current collector that transfers electrical signals to the first electrode material 12 and collects the accumulated charges and may be made of a metallic foil, a conductive polymer, or the like. The metallic foil may be made of stainless steel, copper, nickel, or the like.

In addition, although not shown, the first electrode material is manufactured as a sheet in a solid sheet without using the first conductive sheet, such that it can be used as the first electrode.

The first electrode 10 is pre-doped with lithium ions. Wherein the potential of the first electrode may be lowered to approximately 0 V and thus, the potential difference between the first electrode and the second electrode is increased, thereby making it possible to improve the energy density and output characteristics of the lithium ion capacitor.

The second electrode 20 may be made by forming a second electrode material 22 on a second conductive sheet 21.

The second electrode material 22 is not specifically limited but may use, for example, activated carbon and a mixture of the activated carbon, the conductive material, and a binder. In other embodiments, the second electrode material 22 may be a composite electrode, e.g. a binderless composite electrode, of the type described in, for example, U.S. Pat. No. 10,600,582, entitled “Composite Electrode,” issued on Mar. 24, 2020; U.S. Pat. No. 9,001,495, entitled “High power and high energy electrodes using carbon nanotubes,” issued on Apr. 7, 2015 and also U.S. Pat. No. 9,218,917, entitled “Energy storage media for ultracapacitors,” issued on Dec. 22, 2015, the entire disclosures of which are incorporated by reference herein.

The thickness of the second electrode material 22 is not specifically limited but may be formed to be, for example, 15 to 100 μm.

The second conductive sheet 21 serves as a current collector that transfers electrical signals to the second electrode material 22 and collects the accumulated charges and may be made of a metallic foil, a conductive polymer, or the like. The metallic foil may be made of aluminum, stainless steel, or the like.

In addition, although not shown, the second electrode material is manufactured as a sheet in a solid sheet without using the second conductive sheet, such that it can be used as the second electrode.

A separating membrane 30 may be disposed between the first and second electrodes in order to provide electrical insulation therebetween and the separating membrane 30 may be made of porous materials to transmit ions. In this case, an example of a porous material may include, for example, polypropylene, polyethylene, polytetrafluoroethylene, a glass fiber, or the like.

An electrolyte E may be the electrolyte for the lithium ion capacitor according to the exemplary embodiments described herein.

In some embodiments, the electrolyte E may include a lithium salt dissolved in a solvent mixture. In some embodiments, the electrolyte E may include additives as described herein.

In some embodiments the lithium salt may include a lithium cation paired with an anion. In some embodiments, the anion may be an organic anion which comprises a plurality of halogen functional groups, e.g., at least two, at least three, at least four, at least five, or at least six such halogen groups. In some embodiments the halogen functional groups may be fluorine functional groups. In some embodiments, such an organic anion may be selected such that, during the operation of the capacitor 1 the halogen functional groups require relatively high electrochemical activation energy to be liberated from the organic anion.

In some such embodiments, the organic anion performs advantageously during operation of the capacitor 1. The multiple halogen groups provide an abundant source of desired halides (e.g., fluorine) during formation of the capacitor. These desired halide groups react beneficially with available lithium to create highly thermally and electrically stable compounds (e.g., lithium fluoride), thereby increasing the stability of SEI layers formed (as used herein, a passivation layer is also referred to as the solid electrolyte interphase (SEI) layer). However, the relatively high activation energy required to liberate such halide groups from their base molecules can limit the occurrence of side chain reactions even at elevated temperatures.

In some embodiments, the organic anion may be a symmetric molecule centered about a nitrogen atom. In some embodiments, each chain extending from this central atom may include a sulfur containing group such a sulfonyl group (e.g., a sulfonyl halide). In some embodiments, the sulfonyl halide group may contain two, three, four, five or six halogen substituents. In some embodiments, the halogen is fluorine.

For example, in some embodiments the salt may be lithium bis(trifluoromethanesulfonyl)imide (structural formula shown below):

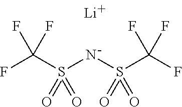

which has three fluorine atoms on each side of the molecule, for a total of six such groups. The fluorine atoms require a higher activation energy to be liberated from the cation than would be the case for similar salts.

In some embodiments, the salt may be lithium bis(fluorosulfonyl)imide (structural formula shown below):

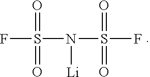

The concentration of the lithium salt is not specifically limited if it can maintain the electric conductivity of the electrolyte. The concentration of the lithium salt may be, for example, 0.1 to 2.5 mol/L, or any subrange thereof. In some embodiments, the concentration of the lithium salt may be, for example, 0.8 to 1.2 mol/L. In some embodiments, the concentration of the lithium salt may be, for example about 1.0 mol/L. The solvent mixture may include a mixture of a plurality of solvent compounds. In some embodiments, a first solvent compound may be an organic solvent which contains no carbonate groups.

In an embodiment, the first solvent compound has a boiling point greater than 90° C., preferably greater than 100° C., and comprises a nitrile group. The first solvent may have the structure shown below in formula (I)

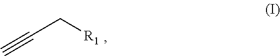

where R₁ is a linear or branched substituted or unsubstituted alkyl group having 1 to 10 carbon atoms, a substituted or unsubstituted monocyclic or polycyclic cycloalkyl group having 3 to 14 carbon atoms, an aryl or a heteroaryl. In a preferred embodiment, R₁ is a linear unsubstituted group having 1 to 5 carbon atoms. Examples of suitable solvents having the structure of formula (I) are butyronitrile, hexanenitrile, propionitrile, valeronitrile, isovaleronitrile, isobutyronitrile, trimethylacetonitrile, benzonitrile, p-tolunitrile, or the like, or a combination thereof.

In an exemplary embodiment, the first solvent compound may be butyronitrile (structural formula shown below).

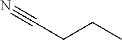

In some embodiments, the first solvent compound may comprise an alkyl butyrate compound having the structure of formula (IIa) or (IIb),

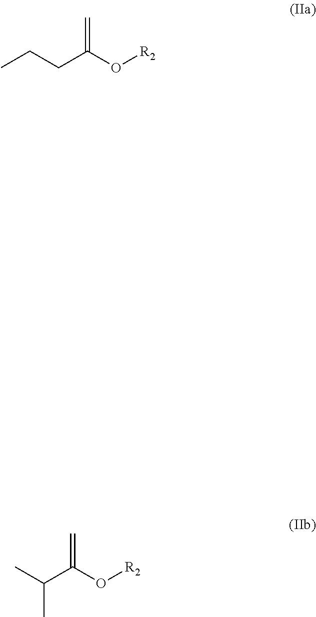

wherein the alkyl moiety (R₂) comprises 1 to 10 substituted or unsubstituted carbon atoms, preferably one to one to substituted or unsubstituted four carbon atoms. In an exemplary embodiment, the alkyl moiety R₂ comprises 1 to 4 unsubstituted carbon atoms. In some embodiments, the first solvent comprises methyl butyrate, methyl isobutyrate, ethyl butyrate, ethyl isobutyrate. propyl butyrate, propyl isobutyrate, butyl butyrate, butyl isobutyrate, or a combination thereof.

In some such embodiments, the lack of carbonate groups advantageously inhibits the formation of unwanted gases such as carbon dioxide during operation of the capacitor 1. In some embodiments the a first solvent compound may be stable against degradation at high temperatures (e.g., up to 65° C., 70° C., 75° C., 80° C., 85° C., 90° C., 95° C., or even 100° C.) at voltages in the range of 0V to 5V or any subrange thereof, such as 2.2 V to 3.8 V.

In some embodiments, the first solvent compound may be in the range of 40 vol % to 80 vol % of the solvent mixture, or in any subrange thereof such as 45%, 50%, 55%. For example, in some embodiments, the first solvent compound may be between 45 and 60 vol % of the solvent mixture.

In some embodiments, a second solvent compound may be selected to improve the performance of the capacitor 1 (See FIG. 1) at lower temperatures (e.g., less than −20° C., −30° C., −40° C., −50° C., −55° C., −60° C.). The second solvent compound may also have a boiling point greater than 90° C., preferably greater than 95° C. For example, in some embodiments, the second solvent compound may be selected to inhibit the formation of lithium dendrites during low temperature operation. In some embodiments, the second solvent compound may inhibit an increase in viscosity of the electrolyte E at lower temperatures.

In some embodiments, the second solvent compound comprises a linear or cyclic carboxylic ester, e.g., a lactone compound containing a 1-oxacycloalkan-2-one structure (—C(═O)—O—), or an analog having unsaturation or heteroatoms replacing one or more carbon atoms of the ring.

In some embodiments, the second solvent compound may be gamma (γ)-butyrolactone, beta (β)-butyrolactone, γ-valerolactone, α-acetylbutyrolactone, or the like, or a combination thereof.

In an exemplary embodiment, the second solvent compound may be gamma-butyrolactone (structural formula below):

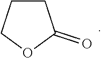

In some embodiments, the second solvent comprises an alkyl carbonate compound, wherein the alkyl moiety comprises one to five carbon atoms. In some embodiments, the second solvent compound comprises ethylene carbonate, diethyl carbonate, propylene carbonate, ethylmethyl carbonate, dimethyl carbonate, or the like, or a combination thereof.

In some embodiments, two or more second solvent compounds may be used in the solvent mixture (and consequently in the electrolyte). For example, a combination comprising two or more of ethylene carbonate, diethyl carbonate, propylene carbonate, ethylmethyl carbonate and dimethyl carbonate may be used in the solvent mixture.

In some embodiments, the second solvent compound may be in the range of 0 vol % to 50 vol %, preferably 2 to 48 vol % of the solvent mixture, or in any subrange thereof. For example, in some embodiments, the second solvent compound may be 20 to 45 vol % of the solvent mixture.

In some embodiments, a third solvent compound may be selected to improve the formation of a passivating solid electrolyte interface (SEI) between the electrolyte E and one or both of the first and second electrodes 10, 20 (see FIG. 1). The third solvent compound may also have a boiling point greater than 90° C., preferably greater than 95° C. In some embodiments, the third solvent compound may include a carbonate group, but may be selected such that said carbonate group is not easily liberated at activation energies present during the operation of the capacitor 1. In some embodiments, the third solvent compound is selected such that a substantial fraction (e.g., greater than 10%, 20%, 30%, 40%, 50%, 60%, 70%, 80%, 90%, 99% or more) of the compound is expended during the formation of the SEI, thus limiting the presence of carbonate groups in the electrolyte E during the operational life of the capacitor 1.

In some embodiments, the third solvent compound comprises an unsaturated cyclic carbonic acid ester. In some embodiments, the third solvent compound may be vinylene carbonate (structural formula below):

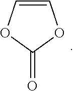

In some embodiments, the third solvent comprises fluoroethylene carbonate. In some embodiments, the third solvent compound may be in the range of 0 vol % to 20 vol %, preferably 2 to 18 vol % of the solvent mixture, or in any subrange thereof. For example, in some embodiments, the third solvent compound may be 1 to 10 vol % of the solvent mixture.

In some embodiments, a fourth solvent compound may be selected to stabilize the lithium salt, e.g., by inhibiting decomposition at high temperatures. The fourth solvent compound may also have a boiling point greater than 90° C., preferably greater than 95° C. The fourth solvent compound may thereby improve the cycle life of the capacitor 1. In some embodiments, the fourth solvent compound may be an organosilicon compound. In some embodiments the organosilicon compound may be selected from the list consisting of: [4-[fluoro(dimethyl)silyl butanenitrile] and others.

In some embodiments, the fourth solvent compound may be in the range of 0 vol % to 5 vol %, preferably 0.5 to 4 vol % of the solvent mixture, or in any subrange thereof. For example, in some embodiments, the fourth solvent compound may be 0 to 1.5 vol % of the solvent mixture.

In some embodiments, the electrolyte E may contain one or more additives, for example, lithium bis(oxalate)borate (LiBOB); lithium hexafluorophosphate (F₆LiP); or lithium difluoro(oxalate)borate (LiFDOB) compounds. These additives may be used to increase high temperature stability.

In some embodiments, the one or more additives may be present at a concentration in the range of 0 to 5 mol/L of the solvent mixture, or in any subrange thereof. For example, in some embodiments, the concentration of the one or more additives may be 0.1 to 2 mol/L of the solvent mixture.

In some embodiments the electrolyte E may be stable against degradation at high temperatures (e.g., up to 65° C., 70° C., 75° C., 80° C., 85° C., 90° C., 95° C., or even 100° C.) at voltages in the range of 0V to 5V or any subrange thereof, such as 2.2V to 3.8V.

In some embodiments, the electrolytes of the present invention allow energy storage devices including EDLCs, LiCs, and LiBs to operate from −55 to 85° C. Additionally, the present electrolytes allow DC life under 85° C. and 3.8 V; under −55° C. degree, the capacity retention of the energy storage device with the electrolyte is about 50% of the capacity under room temperature.

The solvent mixture and the electrolyte described herein are exemplified by the following non-limiting example.

### EXAMPLES

### Example 1

This example was conducted to demonstrate the performance of the solvent mixture and the electrolyte in a lithium capacitor (LiC) cell. Details of the cells are shown in Table 2 below.

The Table 1 below details 3 representative electrolytes that contain the solvent mixture and the electrolyte. All values are in volume percent.

TABLE 1

| Components | Sample #1 | Sample #2 | Sample #3 |
|---|---|---|---|
| Butyronitrile (BCN) | 0.00% | 0.00% | 0.00% |
| Ethylene carbonate (EC) | 20.00% | 20.00% | 20.00% |
| Diethylene carbonate (DC) | 23.30% | 23.30% | 23.30% |
| EMC | 0.00% | 0.00% | 0.00% |
| lithium | 0M | 0M | 0M |
| bis(trifluoromethanesulfonyl)imide | | | |
| (LiTFSI) | | | |
| lithium bis(fluorosulfonyl)imide | 1M | 1M | 1M |
| (LiFSI) | | | |
| lithium difluoro(oxalate)borate | 0M | 0M | 0M |
| (LiFDOB) | | | |
| Vinylene carbonate (VC) | 1% | 1% | 1% |
| Gamma-butyrolactone (GBL) | 0.00% | 0.00% | 0.00% |
| 4-[fluoro(dimethyl)silyl | 0.00% | 0.00% | 1.50% |
| butanenitrile (OS) | | | |
| Fluoroethylene carbonate (FEC). | 0.00% | 0.00% | 0.00% |
| Ethyl butyrate (EB) | 46.70% | 56.70% | 55.20% |
| Propylene carbonate (PC) | 10.00% | 0.00% | 0.00% |
| Pyr14FSI | 0.00% | 0.00% | 0.00% |

The formulations shown in the Table 1 above all display high capacity retention when measured in a lithium capacitor under −45° C. when used in the lithium capacitor whose characteristics are as detailed for CELL #1 in the Table 2. The specific energy of the LiC is greater than or equal to about 22.4 Watt-hour/kilogram with 30% retention being greater than or equal to about 6.7 Watt-hour/kilogram. The electrolyte formulations for the various samples shown in the Table 2 are detailed below.

1. A53-Control (Comparative Sample): 1.0M LiPF₆ in EC/DMC (1:1 by wt)+1% VC;

2. A21: 1.0M LiFP₆ in EC/EMC/MB (20:20:60 by volume)+0.1 M LiDFOB;

3. B43: 1.0M LiFSI in EC/EMC/DEC/PC (20:46.7:23.3:10 by volume)+1% VC;

4. B44: 1.0M LiFSI in EC/EB/DEC/PC (20:46.7:23.3:10 by volume)+1% VC.

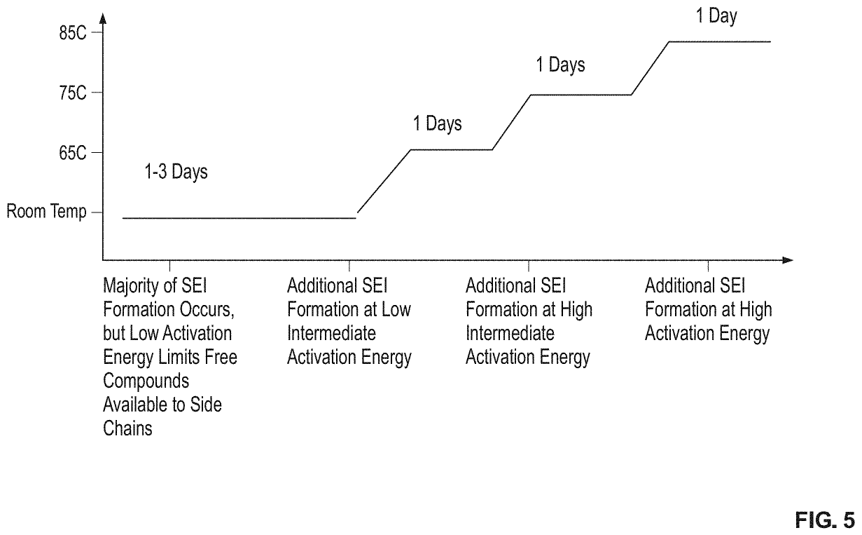

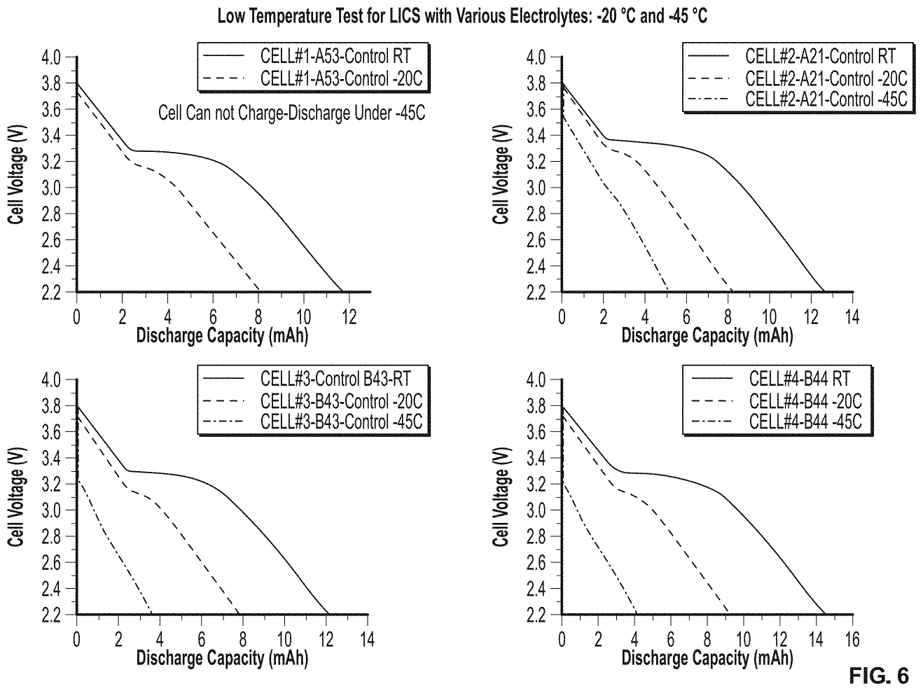

The results are shown in the FIG. 6. FIG. 6 is a graph depicting cell voltage versus discharge capacity. From the FIG. 6, it may be seen that the comparative sample A53 cannot charge or discharge at temperatures lower than −45° C., while the other electrolyte compositions A21, B43 and B44 which are representative of the invention do charge and discharge at temperatures lower than −45° C.

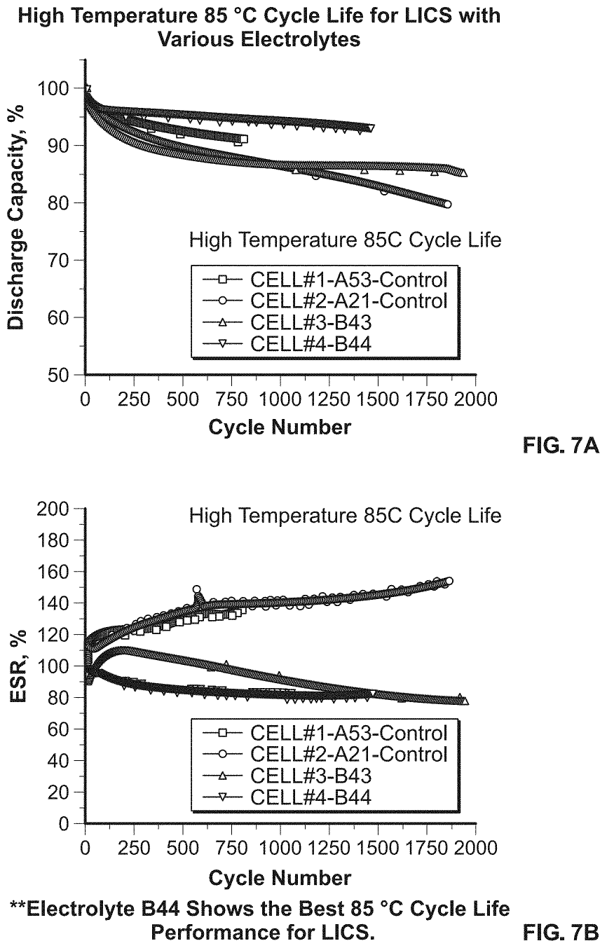

FIG. 7 shows the high temperature life cycle (at 85° C.) for the electrolytes listed in Table 2. The FIG. 7(A) is a graph of discharge capacity versus cycle number while FIG. 7(B) is a graph of ESR versus cycle number. From the FIGS. 7(A) and 7(B) it may be seen that the electrolyte B44 displays the best life cycle performance at 85° C., while the comparative sample A53 displays the least life cycle performance retention.

TABLE 2

| | | | | Total | | | | |
|---|---|---|---|---|---|---|---|---|
| | Cathode#1 | Cathode#2 | Total | Cathode | | | Anode | |
| | Active | Active | Cathode | Active | Cathode | | Active | Anode |
| | Layer | Layer | Active | Layer Press | Mass | Cathode | Layer DS | Active |
| Cell | Thickness | Thickness | Layer Mass | Density | Loading | Porosity, | Thickness | Layer Mass |
| Name | (um) | (um) | (g) | (g/cm³) | (mg/cm²) | % | (um) | (g) |
| CELL#1- | 100 | 100 | 0.1905 | 0.470 | 4.7 | 77.8% | 150 | 0.3398 |
| A53- | | | | | | | | |
| Control | | | | | | | | |
| CELL#2- | 97 | 99 | 0.19 | 0.479 | 4.7 | 77.4% | 126 | 0.2825 |
| A21 | | | | | | | | |
| CELL#3- | 114 | 86 | 0.1921 | 0.474 | 4.7 | 77.6% | 147 | 0.3207 |
| B43 | | | | | | | | |
| CELL#4- | 124 | 118 | 0.2189 | 0.447 | 5.4 | 78.9% | 152 | 0.3308 |
| B44 | | | | | | | | |

| | Anode | | | | Li/ | | ESR/ | |
|---|---|---|---|---|---|---|---|---|
| | Active | Anode | | Cathode/ | Anode | | Internal | |
| | Layer Press | Mass | Anode | Anode | Active | C | Resistance | |
| Cell | Density | Loading | Porosity, | Capacity | Layer, | (10 mA) | (500 mA, 1 ms | RC |
| Name | (g/cm³) | (mg/cm²) | % | Ratio | % | (F.) | pulse) (ohm) | Constant |
| CELL#1- | 1.08 | 8.0 | 43.1% | 0.14 | 8.27% | 26.4 | 0.145 | 3.8 |
| A53- | | | | | | | | |
| Control | | | | | | | | |
| CELL#2- | 1.07 | 6.7 | 43.6% | 0.17 | 11.19% | 28.3 | 0.167 | 4.7 |
| A21 | | | | | | | | |
| CELL#3- | 1.04 | 7.6 | 45.2% | 0.15 | 9.35% | 27.1 | 0.187 | 5.1 |
| B43 | | | | | | | | |
| CELL#4- | 1.04 | 7.8 | 45.3% | 0.17 | 9.31% | 32.5 | 0.187 | 6.1 |
| B44 | | | | | | | | |

### Example 2

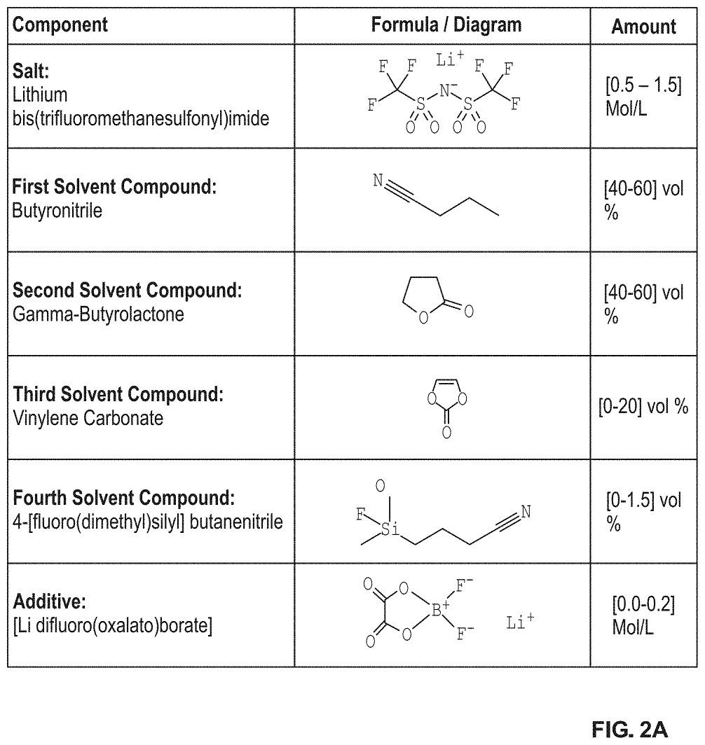

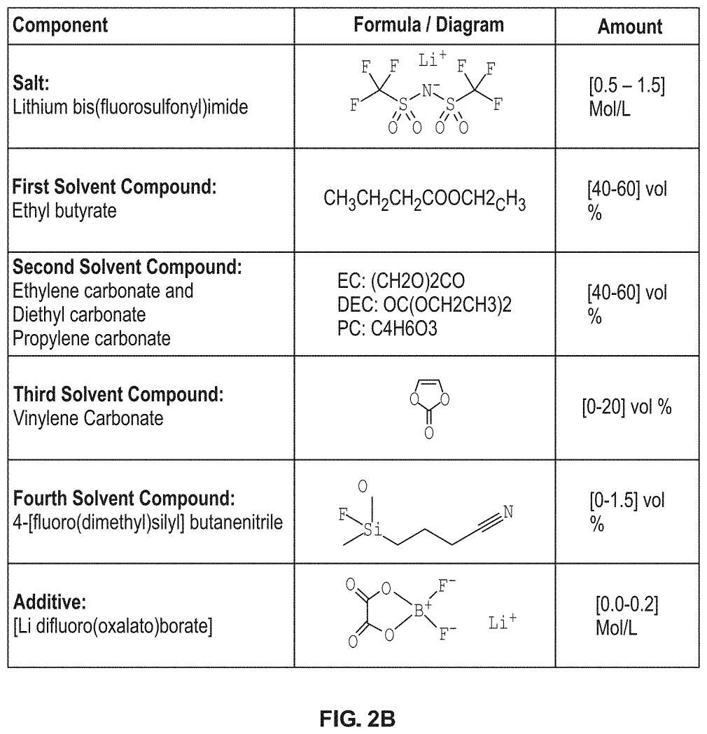

This example was also conducted to demonstrate performance of the electrolytes of this disclosure. FIGS. 2A and 2B show several non-limiting exemplary recipes for the electrolyte E.

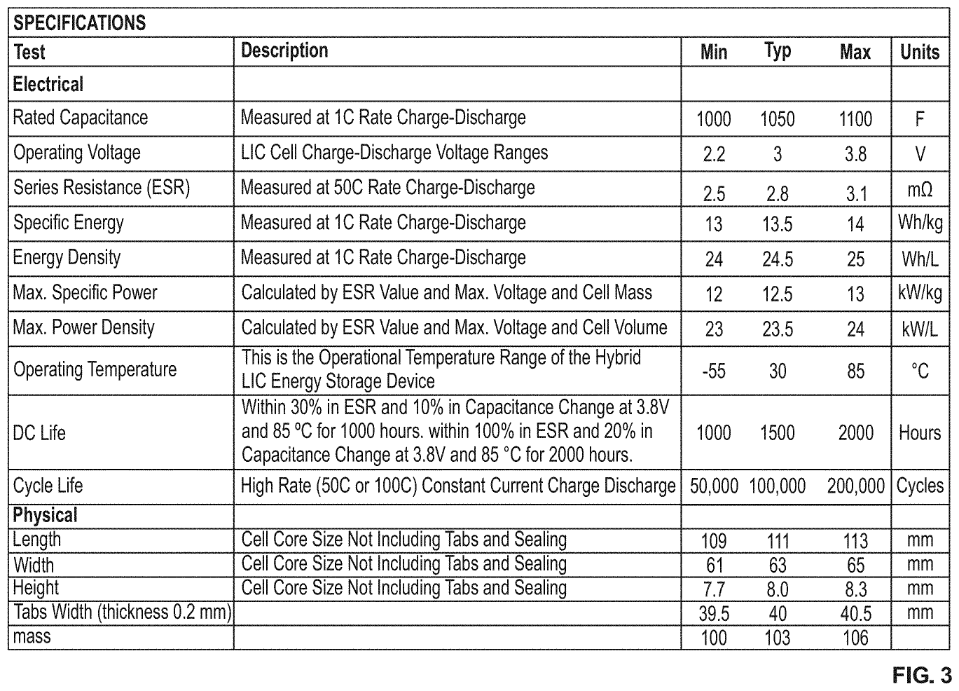

FIG. 3 shows exemplary performance characteristics for an embodiment capacitor 1 featuring an electrolyte E as described above and having at least one electrode formed using a binderless composite electrode of the type described in, for example, U.S. Pat. No. 10,600,582, entitled “Composite Electrode,” issued on Mar. 24, 2020; U.S. Pat. No. 9,001,495, entitled “High power and high energy electrodes using carbon nanotubes,” issued on Apr. 7, 2015 and also U.S. Pat. No. 9,218,917, entitled “Energy storage media for ultracapacitors,” issued on Dec. 22, 2015, the entire disclosures of which are incorporated by reference herein. In some embodiments, the use of such binderless composite electrode is advantageous as it ensures no unwanted reactions between the electrolyte E and polymer binders of the types found in conventional electrodes.

Although the foregoing describes the use of the electrolyte E in a lithium ion capacitor, it will be readily apparent to one skilled in the art that is may also be used in lithium ion batteries, or even in electric double layer capacitors (e.g., by omitting the lithium salt).

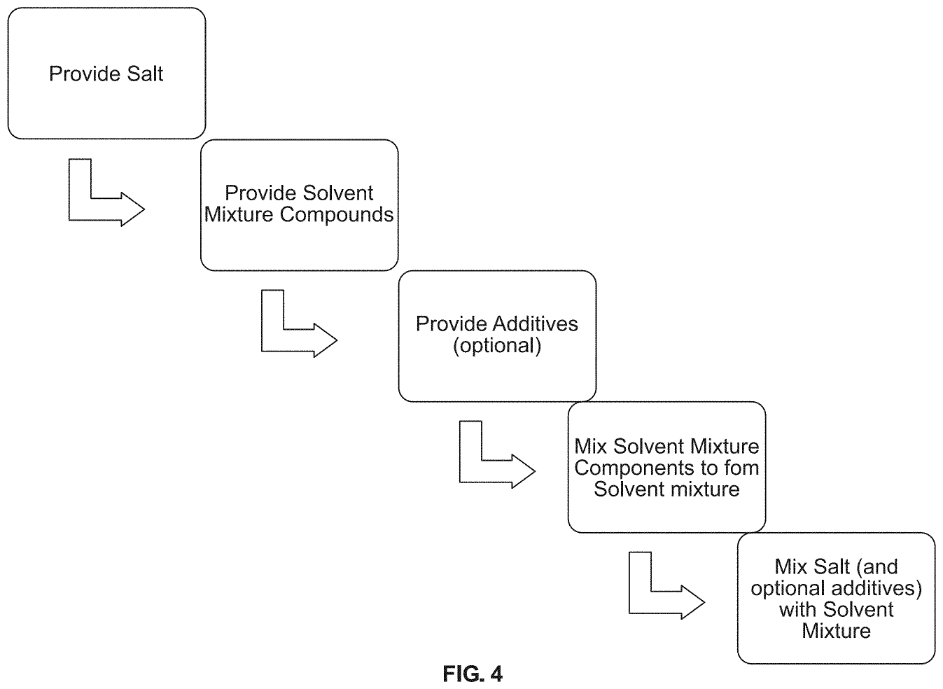

FIG. 4 shows an exemplary process for manufacturing the electrode E.

In some embodiments, the capacitor 1 may be subjected to an initial formation or seasoning process. In the formation process, one or more of the electrodes 10, 20 in the capacitor 1 may become doped with lithium. Further, a passivating SEI layer may be formed at the interface between one or more of the electrodes 10, 20 and the electrolyte E.

In some embodiments, the capacitor 1 is charged to a desired voltage (e.g., the rated operational voltage) and kept at that voltage for periods of time at various temperature. FIG. 5 shows a non-limiting exemplary temperature ramp of this type, where the cell is kept at root temp for a first period (as shown, 1-3 days), and then at successively higher temperatures for subsequent periods (as show, 1 day at each higher temperature).

In some embodiments, the formation process allows the consumption of certain compounds in the electrolyte E (e.g., carbonate compounds used in formation of the SEI layer) at low temperatures, thereby limiting the contribution of such compounds to unwanted gas generating side chain reactions at higher temperatures.

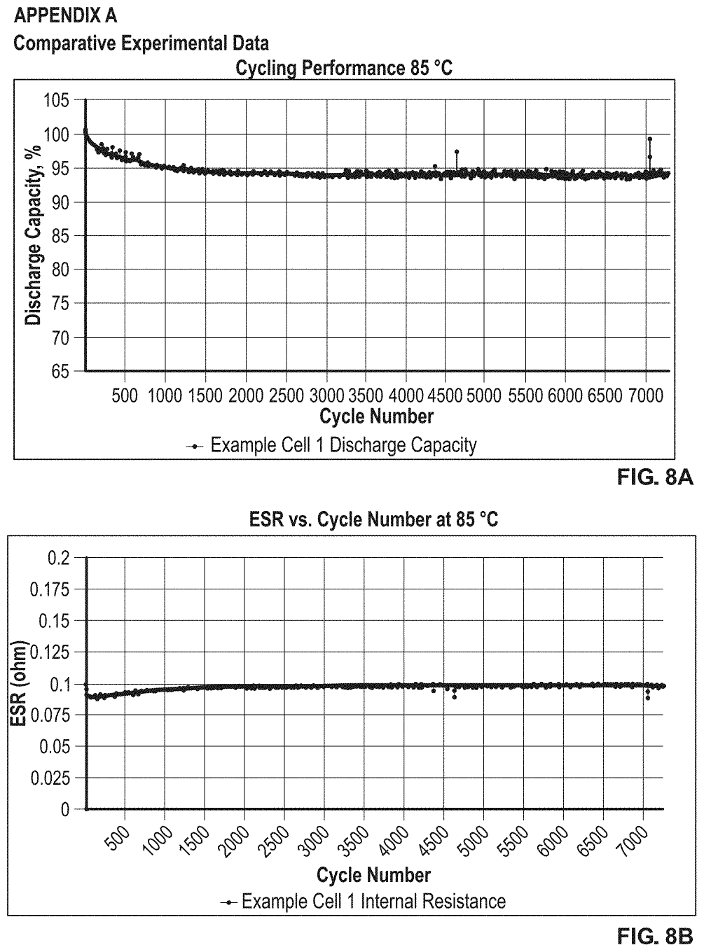

Appendix A is a summary of experimental performance data for an embodiment capacitor 1 featuring an electrolyte E as described above and having at least one electrode formed using a binderless composite electrode compared to a similar device using a conventional electrolyte. FIG. 8A is a graph of percent discharge capacity versus cycle number while the FIG. 8B is a graph that depicts ESR versus cycle number for the Example cell #1 of Table 2.

As used herein the symbol “wt %” means weight percent. For example, when referring to the weight percent of a solute in a solvent, “wt %” refers to the percentage of the overall mass of the solute and solvent mixture made up by the solute.

The entire contents of each of the publications and patent applications mentioned herein are incorporated herein by reference. The present application is related to U.S. Pat. No. 10,600,582, entitled “Composite Electrode,” issued on Mar. 24, 2020; U.S. Pat. No. 9,001,495, entitled “High power and high energy electrodes using carbon nanotubes,” issued on Apr. 7, 2015 and also U.S. Pat. No. 9,218,917, entitled “Energy storage media for ultracapacitors,” issued on Dec. 22, 2015, the entire disclosures of which are incorporated by reference herein for any purpose whatsoever.

In the event that the any of the cited documents conflicts with the present disclosure, the present disclosure shall control.

While the invention has been described with reference to exemplary embodiments, it will be understood that various changes may be made and equivalents may be substituted for elements thereof without departing from the scope of the invention. For example, in some embodiments, one of the foregoing layers may include a plurality of layers there within. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electrolyte comprising:
a solvent mixture comprising:
at least one first solvent component comprising an organic solvent having no carbonate groups;
at least one second solvent component comprising a compound configured to improve the electrochemical properties of the first solvent at low temperatures;
at least one third solvent compound configured to promote formation of a passivating SEI between the electrolyte and an electrode layer; and
a lithium salt dissolved in the solvent mixture.

2. The electrolyte of claim 1, wherein the lithium salt comprises a lithium cation and an organic anion.

3. The electrolyte of claim 2, wherein the organic anion which comprises at least two halogen groups.

4.-7. (canceled)

8. The electrolyte of claim 3, wherein the halogen groups are fluorine groups.

9. The electrolyte of claim 2, wherein the organic anion is a symmetric molecule centered about a nitrogen atom.

10. The electrolyte of claim 9, wherein the organic anion comprises two chains extending from this central atom each comprising a sulfur containing group.

11. The electrolyte of claim 10, wherein the sulfur containing group comprises a sulfonyl group.

12. The electrolyte of claim 11, wherein the sulfonyl group is a sulfonyl halide.

13. The electrolyte of claim 2, wherein the lithium salt comprises lithium bis(trifluoromethanesulfonyl)imide or lithium bis(fluorosulfonyl)imide.

14. The electrolyte of claim 2, wherein the lithium salt consists essentially of lithium bis(trifluoromethanesulfonyl)imide.

15. The electrolyte of claim 1, wherein the first solvent compound comprises at least one of butyronitrile, ethyl butyrate, methyl butyrate or butyl butyrate.

16. The electrolyte of claim 1, wherein the second solvent compound inhibits lithium dendrite formation at temperatures below −40 C.

17. (canceled)

18. (canceled)

19. The electrolyte of claim 16, wherein second solvent compound comprises at least one of gamma-butyrolactone, ethylene carbonate, diethyl carbonate, propylene carbonate, ethylmethyl carbonate or dimethyl carbonate.

20. The electrolyte of claim 1, wherein the third solvent compound is selected such that a substantial fraction of the compound is expended during a formation of the SEI.

21. The electrolyte of claim 1, wherein the third solvent compound comprises vinylene carbonate or fluoroethylene carbonate.

22. The electrolyte of claim 1, further comprising a fourth solvent compound, wherein the fourth solvent compound comprises an organosilicon compound.

23. The electrolyte of claim 22, wherein the fourth solvent compound comprises 4-[fluoro(dimethyl)silyl]butanenitrile.

24. A lithium ion capacitor comprising the electrolyte of claim 1.

25. A lithium ion battery comprising the electrolyte of claim 1.

26. An electric double later capacitor comprising the electrolyte of claim 1.

27.-32. (canceled)
